(19) United States
(12) Patent Application Publication
(10) Pub. No.: US 2021/0049192 A1
(43) Pub. Date: Feb. 18, 2021

(54) INDUSTRIAL ANALYTICS DATA QUERY

(71) Applicant: Rockwell Automation Technologies, Inc., Mayfield Heights, OH (US)

(72) Inventors: Pradeep Kaushik, Sunnyvale, CA (US); Taylor M. Jeong, Fremont, CA (US); Richard W. Sze, Saratoga, CA (US); Jenchen Huang, San Jose, CA (US); Kevin Chao, Mountain View, CA (US)

(21) Appl. No.: 16/538,388

(22) Filed: Aug. 12, 2019

(51) Int. Cl. G06F 16/28; G06F 16/22; G06F 9/451; G06F 16/245; G06F 16/248

(52) U.S. Cl. CPC G06F 16/287; G06F 16/22; G06F 16/248; G06F 16/245; G06F 9/451

(57) ABSTRACT

An industrial data analytics service facilitates gathering, manipulation, and presentation of data obtained from one or more disparate sources and streaming devices. The data analytics service enables users to specify a data source through which to obtain operational data and other information (e.g., gathered data). Subsequent to forming a connection with the data source, a sample data set is obtained by the data analytics service and used to determine an inventory of categories prior to saving the gathered data at the data analytics service. A user may then tailor the inventory of categories so that the data needed to meet business requirements is stored by the data analytics service. The data analytics service may analyze the stored data to determine one or more contexts (e.g., relationships, etc.) and present the contextual information in a storyboard.

### TECHNICAL FIELD

Aspects of the disclosure are related to industrial automation systems, and more particularly, to data analytics systems that interact with industrial automation systems and devices.

### TECHNICAL BACKGROUND

Industrial controllers and their associated input/output (I/O) devices are central to the operation of modern automation systems. These controllers interact with field devices on the plant floor to control automated processes relating to such objectives as product manufacture, material handling, batch processing, supervisory control, and other such applications. Industrial controllers store and execute user-defined control programs to effect decision-making in connection with the controlled process. Such programs can include, but are not limited to, ladder logic, sequential function charts, function block diagrams, structured text, or other such programming structures.

Because of the large number of system variables that must be monitored and controlled in near real-time, industrial automation systems often generate vast amounts of near real-time data. In addition to production statistics, data relating to machine health, alarm statuses, operator feedback (e.g., manually entered reason codes associated with a downtime condition), electrical or mechanical load over time, and the like are often monitored, and in some cases recorded, on a continuous basis. This data is generated by the many industrial devices that can make up a given automation system, including the industrial controller and its associated I/O, telemetry devices for near real-time metering, motion control devices (e.g., drives for controlling the motors that make up a motion system), visualization applications, lot traceability systems (e.g., barcode tracking), etc. Moreover, since many industrial facilities operate on a 24-hour basis, their associated automation systems can generate a vast amount of potentially useful data at high rates. For an enterprise with multiple plant facilities, the amount of generated automation data further increases.

The large quantity of data generated by modern automation systems makes it possible to apply a broad range of plant analytics to the automation systems and processes that make up an industrial enterprise or business. Reports, charts, and other human-readable formats are often available or may be created for plant personnel and others wishing to monitor and review the generated data in either a real-time mode or at a later time after the data has been stored.

For example, data producers, data consumers, machine builders, original equipment manufacturers (OEMs) supplying equipment to a factory, plant operators, machine operators, and other stakeholders may want to review and analyze data collected by facility equipment in order to troubleshoot, perform maintenance, and improve equipment performance in existing or future models. OEMs and other producers and consumers of data, however, are challenged by how to manage the vast amounts of data collected and how to discover early insights from it. For example, to access the generated data, an operational engineer, information technology technician, or other professional having technical knowledge of the facility's systems is typically required.

The above-described deficiencies of today's industrial control and business systems are merely intended to provide an overview of some of the problems of conventional systems and are not intended to be exhaustive. Other problems with conventional systems and corresponding benefits of the various non-limiting embodiments described herein may become further apparent upon review of the following description.

### OVERVIEW

Technology is disclosed herein for enhancing data analytics in an industrial automation environment. In an implementation, a data analytics service receives a request to connect to a source of data or streaming device for an industrial automation operation. Subsequent to receiving the request, the data analytics service connects with and interrogates the data source for a sample data set comprising, for example, time series and transactional information. Prior to saving the sample data set, the data analytics service analyzes the sample data set for one or more categories and initiates presentation of an inventory of the one or more categories. The data analytics service may receive a request to tailor the inventory of the one or more categories. Subsequent to receiving the request, the data analytics service may filter the sample data set in accordance with the request to tailor the inventory. In another implementation, the data analytics service, subsequent to receiving the request to tailor the inventory, may request from the data source a filtered version of the data set.

Subsequent to receiving the request to tailor the inventory of the one or more categories, the analytics service may add additional context by annotating the inventory of the one or more categories in accordance with the request to tailor the inventory. The analytics service may initiate presentation of the tailored inventory. Subsequent to receiving user input accepting the tailored inventory, the analytics service may store and analyze data associated with the tailored inventory. The analytics service then initiates presentation of a storyboard comprising the analyzed data set. The storyboard remains available, on demand, to present real-time, analyzed and updated data.

This Overview is provided to introduce a selection of concepts in a simplified form that are further described below in the Detailed Description. It should be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like references numerals designate corresponding parts throughout the several views. While several implementations are described in connection with these drawings, the disclosure is not limited to the implementations disclosed herein. On the contrary, the intent is to cover all alternatives, modifications, and equivalents.

FIG. 1A illustrates an operational architecture suitable in an exemplary implementation.

FIG. 1B illustrates an operational sequence in an exemplary implementation.

FIG. 2A illustrates a process in an exemplary implementation.

FIG. 2B illustrates a process in an exemplary implementation.

FIG. 3 illustrates a user interface in an exemplary implementation.

FIG. 4 illustrates a user interface in an exemplary implementation.

FIG. 5 illustrates a dialogue box in an exemplary implementation.

FIG. 6 illustrates a user interface in an exemplary implementation.

FIG. 7 illustrates a dialogue box in an exemplary implementation.

FIG. 8 illustrates a user interface in an exemplary implementation.

FIG. 9 illustrates a user interface in an exemplary implementation.

FIG. 10 illustrates a computing system suitable for implementing the various operational environments, architectures, processes, scenarios, and sequences discussed below with respect to the Figures.

### DETAILED DESCRIPTION

Technology is disclosed herein that improves data analysis techniques by tailoring gathered data from disparate sources to meet specific business requirements. In particular, processes employed by a data analytics service are disclosed that allow the data analytics service to optimize how data is retrieved and displayed from disparate sources. Operational data is generated by the many industrial devices that can make up a given automation system, including an industrial controller and its associated I/O devices, telemetry devices for near real-time metering, motion control devices (e.g., drives for controlling the motors that make up a motion system), visualization applications, lot traceability systems (e.g., barcode tracking), sensors, etc. The generated data may be accessed in real-time (e.g., streaming data from components and applications) or from historical data sources like, for example, spreadsheets and databases. The generated data may also be stored locally or on remote servers using a multitude of labels and categories.

In an implementation, a data analytics service connects to one or more data sources and interrogates the one or more data sources to obtain a sample data set of the data comprised therein. Data sources may comprise industrial automation machines, machine systems, databases, documents, applications, etc. From the sample data set, the data analytics service determines an inventory of available categories and presents the inventory in a user interface.

In an embodiment, the data analytics service may receive a request to apply one or more filters to the inventory prior to storing data from the one or more data sources. In an implementation of said embodiment, the data analytics service applies the filter request to the sample data set and loads the information in accordance with the filter request. In another implementation of said embodiment, the data analytics service requests a non-sample data set from the data source that comprises only the data that corresponds with the filter request. The non-sample data set is then loaded by the service. In some embodiments, the loaded data may be saved and analyzed by the data analytics service, which may then present the analyzed data in a generated storyboard.

In another embodiment, the data analytics service may receive a request to annotate the inventory prior to saving data from the one or more data sources. In an implementation of said embodiment, the data analytics service applies the annotation request to the sample data set. In another implementation, the data analytics service requests a non-sample data set from the data source and applies the annotation request to the non-sample data set. To apply the annotation request, the data analytics service may generate and insert into the data set a new field that corresponds with the requested annotation. The annotated data may be saved and analyzed by the data analytics service, which may then present the annotated data in a generated storyboard.

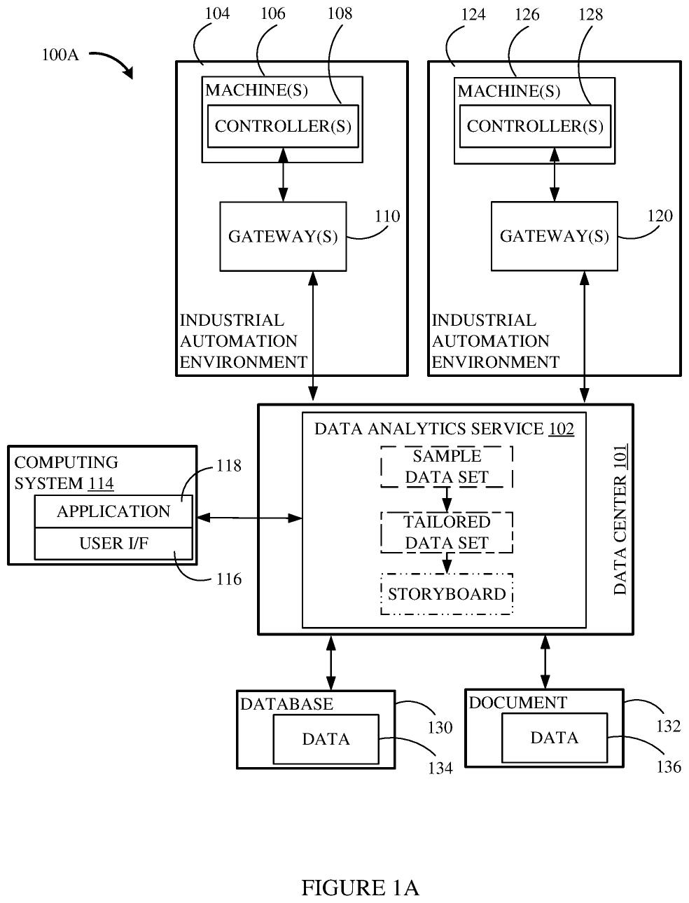

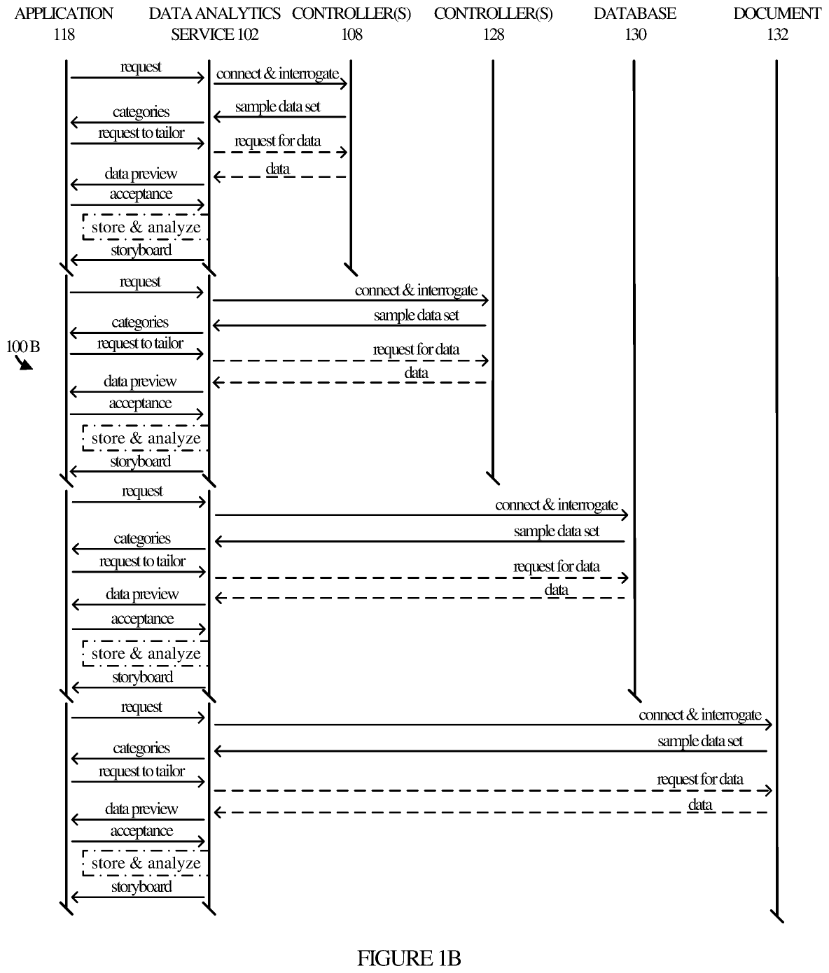

Turning now to FIG. 1A, an operational architecture 100A is shown in an example implementation of a data analytics process having disparate sources of data. Operational architecture 100A provides an example of a data analysis system that may be utilized to implement the data gathering, manipulation, and presentation operations disclosed herein, but other environments could also be used. Operational architecture 100A includes data center 101, industrial automation environment 104, computing system 114, industrial automation environment 124, database 130, and document 132. Industrial automation environment 104, industrial automation environment 124, database 130, and document 132 are example sources from which data may be obtained. Note that there may be many more sources of data, but the number of sources shown in FIG. 1A has been restricted for clarity.

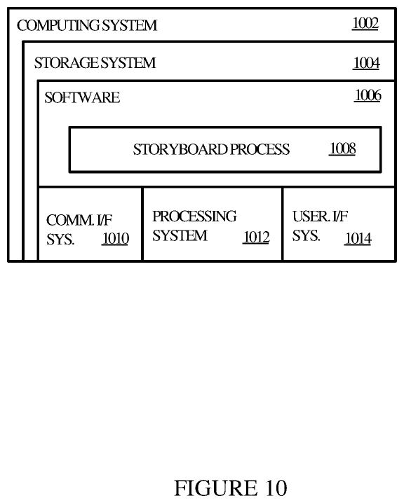

Data center 101 comprises data analytics service 102. Data analytics service 102 is implemented on one or more computing systems in data center 101, of which computing system 1002 in FIG. 10 is representative. Data analytics service 102 comprises one or more program applications, components, modules, and the like that implement storyboard process 200B.

To facilitate delivery of analytics information to data producers, data consumers, machine builders, OEMs, plant operators, and other stakeholders, data analytics service 102 is configured to employ storyboard process 200B or variations thereof to connect to one or more data sources and receive data gathered from the one or more sources, for example, from databases, documents, computing devices, applications, gateways, machines, and/or machine systems of plants. Data analytics service 102 also employs storyboard process 200B or variations thereof to process, analyze, and present the gathered data to the various stakeholders. In one embodiment, data analytics service 102 is a cloud-based system accessible via the Internet or similar communication protocols; however, other types of systems are also contemplated herein.

Data analytics service 102 comprises a storyboard system comprising one or more graphical dashboards configured to present contextual data. The storyboard system may be accessible to various stakeholders using, for example, tools such as FACTORYTALK® Analytics software provided by Rockwell Automation, Inc. Through the storyboard system, data analytics service 102 may initiate presentation of storyboards in user interface 116 of computing system 114. Stakeholders may interact with data analytics service 102 via user interface 116 to generate data filters, apply data annotations, and perform other methods to facilitate orchestration of the gathered data prior to its presentation in a storyboard.

Industrial automation environment 104 comprises machine(s) 106, controller(s) 108, and gateway(s) 110. Industrial automation environment 124 comprises machine(s) 126, controller(s) 128, and gateway(s) 120. Industrial automation environment 104 and industrial automation environment 124 are separate entities and may comprise an automobile manufacturing factory, food processing plant, oil drilling operation, microprocessor fabrication facility, or some other type of industrial enterprise. Note that there would typically be many more machine systems in most industrial automation environments, but the number of machine systems shown in FIG. 1A has been restricted for clarity.

Machine(s) 106, 126 may comprise a sensor, drive, pump, filter, drill, motor, robot, fabrication machinery, mill, printer, or any other industrial automation equipment or element thereof, including associated control systems. Controller(s) 108, 128 may include automation controllers, programmable logic controllers (PLCs), programmable automation controllers (PACs), or any other controllers used in automation control.

Each controller(s) 108, 128 is configured to generate a predefined data structure populated with specific data. The format and configuration of the respective data structures may be the same, but the data contained therein is respective to each machine(s) 106, 126. The specific data, in embodiments of the invention, includes the following operational data: identifying information, machine state information, actual part production or count information, ideal part production or count information, machine event information, and specific machine variable information. The identifying information may identify the maker or builder of the machine, the owner of the machine, the supervisor of an operation(s), the machine operator, the shift date and time, machine location, etc. and allows the data analytics service 102 to group or categorize the data for a single entity or identifying feature.

In some embodiments, the machine state information includes data identifying a history of the operating states of the machine and the times in which each of the operating states was encountered. The actual part count information includes data indicating how many parts the particular machine has made over a period or periods of time. The part count information may include both the number of good parts produced as well as the number of bad parts produced. The ideal part count information includes the number of good parts that the machine should have produced during productive states such as, for example, when the machine was in one or more operational states and with adequate supplies to produce parts. The ideal part production or count information may be calculated based on a comparison of the duration of productive machine states with the ideal time it takes to produce a good part in a productive machine state.

The machine event information includes information related to logged events in the machine. Events such as low or inadequate supplies, faults, operation starts and stops, and other flagged and stored events. The specific machine variable information may include the data values for specific variables that are important or of interest to the various stakeholders and that may be included in at least one of the storyboards.

A user may engage with data analytics service 102 to select one or more data sources from which to further select one or more data objects (e.g., tables, queries, views, etc.). For example, data analytics service 102 may obtain operational data comprising the selected one or more data objects or other information from machine(s) 106, 126 by connecting with or linking to gateway(s) 110, 120. Operational data from machine(s) 106, 126 may be transmitted to the data analytics service 102 via gateway(s) 110, 120. To accomplish this, gateway(s) 110, 120 include the protocols needed to communicate with controller(s) 108, 128 and data analytics service 102 including security protocols, handshaking protocols, and the like. In some embodiments, data analytics service 102 may comprise the protocols needed to communicate with gateway(s) 110, 120. Note that though FIG. 1A comprises a dedicated gateway(s) 110 for machine(s) 106 and a dedicated gateway(s) 120 for machine(s) 126, it is within the scope of this invention for data analytics service 102 to obtain data from a single gateway that communicates with a plurality of machines (not shown). Other sources of industrial automation data that may also be available to data analytics service 102 are considered within the scope of the invention.

Data analytics service 102 may also obtain operational data and/or other information (i.e., gathered data) from database 130. Database 130 may comprise a disk, tape, integrated circuit, server, or some other memory device. Database 130 may reside in a single device or may be distributed among multiple memory devices. Database 130 comprises data 134, which may include structured data (e.g., tabular data, data that is in rows and columns, data that is well defined, etc.), unstructured data (e.g., raw data sets, text, pictures, videos, audio, directories, etc.), and semi-structured data (e.g., document-oriented databases, etc.). Database 130 may be connected to data analytics service 102 via a local network or a remote network.

In another embodiment, data analytics service 102 may obtain gathered data from document 132. Document 132 may comprise one or more of the following: a word processing document, a PDF, a spreadsheet workbook, a presentation document, a digital notebook, a diagram file, an image, a video, an audio file, or some other file type. Document 132 comprises data 136, which may include structured data or unstructured data. Document 132 may be connected to data analytics service 102 via a local network or a remote network.

Computing system 114 comprises user interface 116 and application 118. Computing system 114 is representative of any computing apparatus, system, or systems on which application 118 or variations thereof may be suitably implemented. Application 118 runs locally with respect to a user and is implemented by computing system 114, of which computing system 1002 of FIG. 10 is representative. Applications 118 comprises one or more program components, modules, and the like that implement storyboard process 200A.

Computing system 114 provides an example of a computing system that could be used as either a server or a client device in some implementations, although such devices could have alternative configurations. Examples of computing system 114 include mobile computing devices, such as cell phones, tablet computers, laptop computers, notebook computers, and gaming devices, as well as any other type of mobile computing devices and any combination or variation thereof. Examples of computing system 114 also include desktop computers, server computers, and virtual machines, as well as any other type of computing system, variation, or combination thereof. In some implementations, computing system 114 could comprise a mobile device capable of operating in a server-like fashion which, among other uses, could be utilized in a wireless mesh network. Computing system 114 may reside in a single device or may be distributed across multiple devices.

FIG. 1B illustrates an operational sequence 100B in an exemplary implementation in which application 118 employs storyboard process 200A and data analytics service 102 employs storyboard process 200B. Storyboard process 200A may be implemented in program instructions in the context of any of the software applications, modules, components, or other such programming elements of application 118. Storyboard process 200B may also be implemented in program instructions in the context of any of the software applications, modules, components, or other such programming elements of data analytics service 102.

To begin, application 118 sends a request to data analytics service 102 to connect to controller(s) 108. In response to receiving the request, data analytics service 102 connects to controller(s) 108. Subsequent to forming a connection with controller(s) 108, data analytics service 102 interrogates controller(s) 108 for data gathered by machine(s) 106. The gathered data may comprise operational data, time series data, transactional data, or any other information stored by machine(s) 106.

Subsequent to receiving the request, controller(s) 108 sends a sample data set to data analytics service 102. Data analytics service 102 analyzes the sample data set to determine which categories of data are available and generates an inventory of available categories of data. Data analytics service 102 transmits the inventory of available categories of data to application 118.

Application 118 displays the inventory of available categories in a user interface (e.g., user interface 116). Application 118 receives a selection to tailor the inventory of categories and sends to data analytics service 102 a request to tailor the inventory of available categories in accordance with the received selection. For example, application 118 may generate the request to tailor the inventory based on the received selection to tailor the inventory. The request to tailor the inventory may comprise a request to filter the inventory (e.g., exclude data corresponding to selected categories, include only data corresponding to selected categories, etc.) and/or to annotate the inventory (e.g., add a field not present in the original data set).

In an embodiment and in response to receiving a request to filter the inventory, data analytics service 102 transmits a request to controller(s) 108 for data from machine(s) 106 that comports with the inclusion or exclusion of data as defined in the request to tailor the inventory. Controller(s) 108 responds to the request by providing the filtered data set to data analytics service 102. Subsequent to receiving the filtered data set, data analytics service 102 loads the filtered data set.

In another embodiment and in response to receiving a request to filter the inventory, data analytics service 102 loads data from the sample data in accordance with the request to tailor the inventory (e.g., by including or excluding data from the sample data set).

The request to tailor the inventory may comprise a request to annotate the data set. In response to receiving a request to annotate the data set, data analytics service 102 may generate a new field in accordance with the request to annotate and incorporate the new field into the received data set.

Data analytics service 102 then generates a preview of the tailored data set (i.e., the filtered and/or annotated data set) and sends the preview to application 118, which displays the preview in a user interface. Application 118 may receive an indication that the tailored inventory is accepted, and in response, may generate and send a notification of the acceptance to data analytics service 102.

Data analytics service 102 saves the loaded data corresponding to the tailored inventory subsequent to receiving the notification of acceptance. Data analytics service 102 analyzes the saved data to discover and record relationships, both explicit and inferred, between the saved data points (i.e., determines a context for the data points). A search index may be employed by data analytics service 102 to facilitate the contextual analysis (e.g., data analytics service 102 loads data points into the search index). Data analytics service 102 then generates a storyboard comprising the contextual analysis and transmits the storyboard to application 118.

Next, application 118 sends a request to data analytics service 102 to connect to controller(s) 128. In response to receiving the request, data analytics service 102 connects to controller(s) 128. Subsequent to forming a connection with controller(s) 128, data analytics service 102 interrogates controller(s) 128 for data gathered by machine(s) 126. The gathered data may comprise operational data, time series data, transaction al data, or any other information stored by machine(s) 126.

Subsequent to receiving the request, controller(s) 128 sends a sample data set to data analytics service 102. Data analytics service 102 analyzes the sample data set to determine which categories of data are available and generates an inventory of available categories of data. Data analytics service 102 transmits the inventory of available categories of data to application 118.

Application 118 displays the inventory of available categories in a user interface (e.g., user interface 116). Application 118 receives a selection to tailor the inventory of categories and sends to data analytics service 102 a request to tailor the inventory of available categories in accordance with the received selection. For example, application 118 may generate the request to tailor the inventory based on the received selection to tailor the inventory. The request to tailor the inventory may comprise a request to filter the inventory (e.g., exclude data corresponding to selected categories, include only data corresponding to selected categories, etc.) and/or to annotate the inventory (e.g., add a field not present in the original data set).

In an embodiment and in response to receiving a request to filter the inventory, data analytics service 102 transmits a request to controller(s) 128 for data from machine(s) 126 that comports with the inclusion or exclusion of data as defined in the request to tailor the inventory. Controller(s) 128 responds to the request by providing the filtered data set to data analytics service 102. Subsequent to receiving the filtered data set, data analytics service 102 loads the filtered data set.

In another embodiment and in response to receiving a request to filter the inventory, data analytics service 102 loads data from the sample data in accordance with the request to tailor the inventory (e.g., by including or excluding data from the sample data set).

The request to tailor the inventory may comprise a request to annotate the data set. In response to receiving a request to annotate the data set, data analytics service 102 may generate a new field in accordance with the request to annotate and incorporate the new field into the received data set.

Data analytics service 102 then generates a preview of the tailored data set (i.e., the filtered and/or annotated data set) and sends the preview to application 118, which displays the preview in a user interface. Application 118 may receive an indication that the tailored inventory is accepted, and in response, may generate and send a notification of the acceptance to data analytics service 102.

Data analytics service 102 saves the loaded data corresponding to the tailored inventory subsequent to receiving the notification of acceptance. Data analytics service 102 analyzes the saved data to discover and record relationships, both explicit and inferred, between the saved data points (i.e., determines a context for the data points). A search index may be employed by data analytics service 102 to facilitate the contextual analysis (e.g., data analytics service 102 loads data points into the search index). Data analytics service 102 then generates a storyboard comprising the contextual analysis and transmits the storyboard to application 118.

Next, application 118 sends a request to data analytics service 102 to connect to database 130. In response to receiving the request, data analytics service 102 connects to database 130. Subsequent to forming a connection with database 130, data analytics service 102 interrogates database 130 for data gathered by database 130. The gathered data may comprise operational data for an industrial automation operation, time series data, transactional data, or any other information stored by database 130.

Subsequent to receiving the request, database 130 sends a sample data set to data analytics service 102. Data analytics service 102 analyzes the sample data set to determine which categories of data are available and generates an inventory of available categories of data. Data analytics service 102 transmits the inventory of available categories of data to application 118.

Application 118 displays the inventory of available categories in a user interface (e.g., user interface 116). Application 118 receives a selection to tailor the inventory of categories and sends to data analytics service 102 a request to tailor the inventory of available categories in accordance with the received selection. For example, application 118 may generate the request to tailor the inventory based on the received selection to tailor the inventory. The request to tailor the inventory may comprise a request to filter the inventory (e.g., exclude data corresponding to selected categories, include only data corresponding to selected categories, etc.) and/or to annotate the inventory (e.g., add a field not present in the original data set).

In an embodiment and in response to receiving a request to filter the inventory, data analytics service 102 transmits a request to database 130 for data that comports with the inclusion or exclusion of data as defined in the request to tailor the inventory. Database 130 responds to the request by providing the filtered data set to data analytics service 102. Subsequent to receiving the filtered data set, data analytics service 102 loads the filtered data set.

In another embodiment and in response to receiving a request to filter the inventory, data analytics service 102 loads data from the sample data in accordance with the request to tailor the inventory (e.g., by including or excluding data from the sample data set).

The request to tailor the inventory may comprise a request to annotate the data set. In response to receiving a request to annotate the data set, data analytics service 102 may generate a new field in accordance with the request to annotate and incorporate the new field into the received data set.

Data analytics service 102 then generates a preview of the tailored data set (i.e., the filtered and/or annotated data set) and sends the preview to application 118, which displays the preview in a user interface. Application 118 may receive an indication that the tailored inventory is accepted, and in response, may generate and send a notification of the acceptance to data analytics service 102.

Data analytics service 102 saves the loaded data corresponding to the tailored inventory subsequent to receiving the notification of acceptance. Data analytics service 102 analyzes the saved data to discover and record relationships, both explicit and inferred, between the saved data points (i.e., determines a context for the data points). A search index may be employed by data analytics service 102 to facilitate the contextual analysis (e.g., data analytics service 102 loads data points into the search index). Data analytics service 102 then generates a storyboard comprising the contextual analysis and transmits the storyboard to application 118.

Finally, application 118 sends a request to data analytics service 102 to connect to document 132. In response to receiving the request, data analytics service 102 connects to document 132. Subsequent to forming a connection with document 132, data analytics service 102 interrogates document 132 for data gathered by document 132. The gathered data may comprise operational data for an industrial automation operation, time series data, transactional data, or any other information stored by document 132.

Subsequent to receiving the request, document 132 sends a sample data set to data analytics service 102. Data analytics service 102 analyzes the sample data set to determine which categories of data are available and generates an inventory of available categories of data. Data analytics service 102 transmits the inventory of available categories of data to application 118.

Application 118 displays the inventory of available categories in a user interface (e.g., user interface 116). Application 118 receives a selection to tailor the inventory of categories and sends to data analytics service 102 a request to tailor the inventory of available categories in accordance with the received selection. For example, application 118 may generate the request to tailor the inventory based on the received selection to tailor the inventory. The request to tailor the inventory may comprise a request to filter the inventory (e.g., exclude data corresponding to selected categories, include only data corresponding to selected categories, etc.) and/or to annotate the inventory (e.g., add a field not present in the original data set).

In an embodiment and in response to receiving a request to filter the inventory, data analytics service 102 transmits a request to document 132 for data that comports with the inclusion or exclusion of data as defined in the request to tailor the inventory. Document 132 responds to the request by providing the filtered data set to data analytics service 102. Subsequent to receiving the filtered data set, data analytics service 102 loads the filtered data set.

In another embodiment and in response to receiving a request to filter the inventory, data analytics service 102 loads data from the sample data in accordance with the request to tailor the inventory (e.g., by including or excluding data from the sample data set).

The request to tailor the inventory may comprise a request to annotate the data set. In response to receiving a request to annotate the data set, data analytics service 102 may generate a new field in accordance with the request to annotate and incorporate the new field into the received data set.

Data analytics service 102 then generates a preview of the tailored data set (i.e., the filtered and/or annotated data set) and sends the preview to application 118, which displays the preview in a user interface. Application 118 may receive an indication that the tailored inventory is accepted, and in response, may generate and send a notification of the acceptance to data analytics service 102.

Data analytics service 102 saves the loaded data corresponding to the tailored inventory subsequent to receiving the notification of acceptance. Data analytics service 102 analyzes the saved data to discover and record relationships, both explicit and inferred, between the saved data points (i.e., determines a context for the data points). A search index may be employed by data analytics service 102 to facilitate the contextual analysis (e.g., data analytics service 102 loads data points into the search index). Data analytics service 102 then generates a storyboard comprising the contextual analysis and transmits the storyboard to application 118.

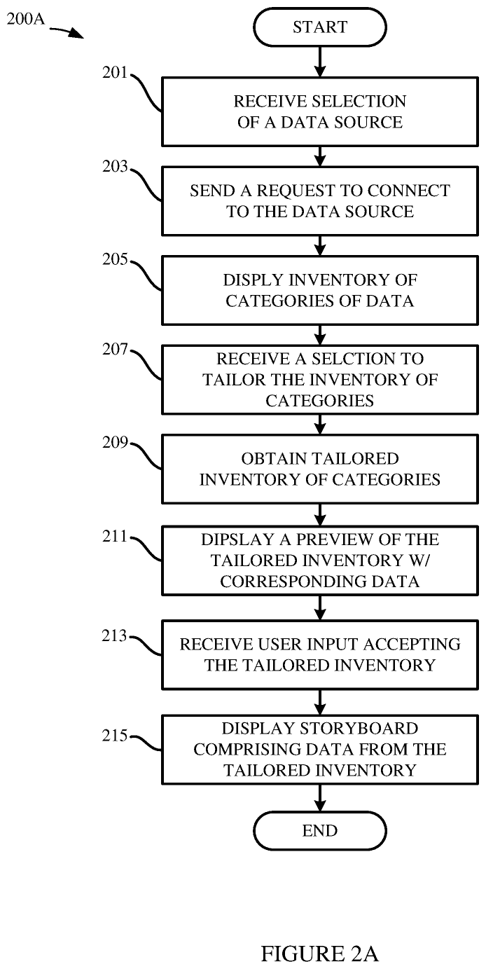

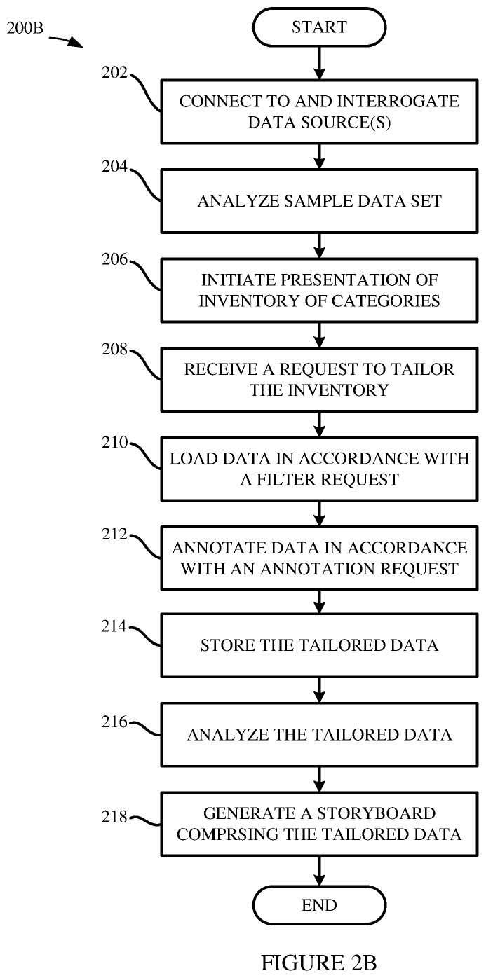

Referring to FIG. 2A, a computing system employing storyboard process 200A (e.g., computing system 114) receives, via user input, a selection of a data source from which data is to be obtained (step 201). The selection may include a dynamic data source, a static data source, machine(s) 106, machine(s) 126, database 130, document 132, or any other available source of data. Subsequent to receiving the selection, the computing system may send a request to connect or link to one or more of the data sources in accordance with the selection of the data source (step 203).

Subsequent to obtaining an inventory of available categories of data, the computing system displays the inventory of available categories at step 205. The inventory of available categories may be displayed in user interface 116. One or more options to tailor the inventory of available categories (e.g., an option to filter, an option to annotate, etc.) may also be displayed in the user interface. A selection of the one or more options to tailor the inventory may cause a filter dialogue box to be displayed, the filter dialogue box comprising additional options to include or exclude one or more of the available categories. A selection of the one or more options to tailor the inventory may also cause an annotation dialogue box to be displayed, the annotation dialogue box comprising additional options to create a new field and apply the new field to the inventory of categories.

The computing system receives a selection to tailor the inventory of categories at step 207. Subsequent to receiving the selection, the computing system may generate and send a notification of the selection to a data analytics service. Also, subsequent to receiving the selection, the computing system may obtain a tailored inventory of categories (step 209). To obtain the tailored inventory of categories, the computing system may receive the tailored inventory from the data analytics service or other source. Additionally, to obtain the tailored inventory of categories, the computing system may generate the tailored inventory.

The computing system may display a preview of the tailored inventory of categories along with data points that correspond with their respective categories (step 211). Via a user interface, the computing system may receive user input indicating an acceptance of the tailored inventory (step 213). Subsequent to receiving the user input accepting the tailored inventory, the computing system may generate and send a notification of the user acceptance of the tailored inventory to a data analytics service. Subsequent to receiving the user input accepting the tailored inventory, the computing system may obtain a storyboard comprising one or more reports that detail an analysis of the data correlating with the tailored inventory of categories. The computing system may display the storyboard in a user interface (step 215).

FIG. 2B illustrates a storyboard process 200B for direct querying data sources in an exemplary implementation. Storyboard process 200B begins by connecting or linking a data analytics service (e.g., data analytics service 102) to one or more selected data sources (e.g., dynamic data sources, static data sources, machine(s) 106, machine(s) 126, database 130, document 132, etc.) at step 202. The connection may occur, for example, over an intranet, an extranet, the Internet, or some combination thereof. In one embodiment, the service connects to one or more machine data sources via a gateway. In another embodiment, the service connects to one or more machine data sources via a system controller. In an exemplary implementation, the service connects to a database (e.g., a SQL database). In another exemplary implementation, the service connects to a document file. Connections may be also be made to additional sources of data available to the service (e.g., web services, logic machines, etc.).

Subsequent to linking to the data source, the data analytics service interrogates the data source (step 202). By way of example, a data source may be interrogated when it receives a request for all, or part of the data contained therein. For example, a machine may be interrogated when an industrial controller receives a request from a data analytics service for operational data pertaining to the machine. In another example, a gateway device, in response to a request from the service, receives the requested data from another point of data streaming in an industrial automation environment such as a database storage system, application integration platform, or the like. In an exemplary implementation, the data analytics service may interrogate a database by querying the database directly and obtaining the requested information therefrom. In another exemplary implementation, the data analytics service may query a document directly and obtain the requested information therefrom. In some embodiments, the service may request only a portion of an available data set.

In response to obtaining the requested data from one or more data sources, the service may determine a data structure for the requested data. The data structure comprises details for data points gathered in each of the categories of information available in the data set. For example, data analytics service may determine which categories are available by reviewing one or more data structures and/or by evaluating one or more data types for the gathered data. The service may also determine a format and/or configuration of the requested information. The data analytics service may then generate an inventory of available categories based on the determined data structure and initiate presentation of an inventory of available categories (step 206).

As noted above, the service may not require a complete data set to perform its analysis. For example, in one embodiment the data analytics service receives a portion (e.g., less than the whole) of an available data set for an industrial controller. From said portion, the service determines which categories of information are available by examining the data structure of the gathered data comprised in said portion. The data analytics service may present the data structures, data types, formats, configurations, and various other categories of information to a user (e.g., a stakeholder, an application, etc.) prior to loading and/or saving the set of gathered data.

In an exemplary implementation, the service presents a user with one or more options to filter a complete gathered data set prior to loading and/or saving all of the data points included in the gathered data set. The user may engage with the service to indicate which categories of data should be included in or excluded from a tailored inventory. In response to receiving from the user an indication that the data set should be filtered (step 208), the service may proceed to retrieve only the data that corresponds to the desired categories of information and refrains from obtaining the undesired categories of information (step 210).

In another exemplary embodiment, the service may present the user with one or more options to annotate the data set prior to loading and/or saving all of the data included in the data set. Annotation features may allow users to add computing derived fields to storyboards and reports using a built-in expression language and a set of pre-defined functions before creating a new, or updating an existing, storyboard. An annotation feature may, by way of example, provide a means for a user to create a custom field in which to present the operational data. The data may be annotated according to the user defined request before or after applying any filters received in step 208 (step 212). Data annotation is enabled for all data source connectors.

Subsequent to obtaining the filtered data set and/or applying any user defined annotations, the data analytics service may store the tailored data locally or remotely (step 214). Enabling a data set to be filtered prior to loading or saving the entirety of the data set has the technical effect of reducing the quantity of information stored on computer resources and increases computational efficiencies by, for example, reducing the time it takes to perform computational analysis which in turn reduces overall energy requirements because, in part, the system has less data to orchestrate. Existing solutions fail to provide these benefits in part because they require an entire data set to be loaded and/or saved prior to commencing analysis of the data set.

In an embodiment, a data analytics service identifies one or more relationships and/or one or more contexts in the tailored data set. The service may perform additional analytic methodologies to the tailored data set (step 216). The service may further orchestrate and organize the tailored data set to present the analyzed data in a visual storyboard (e.g., dashboard) that comprises multiple reports (Step 218). Each report may provide a visualization for one or more aspects of an industrial operation.

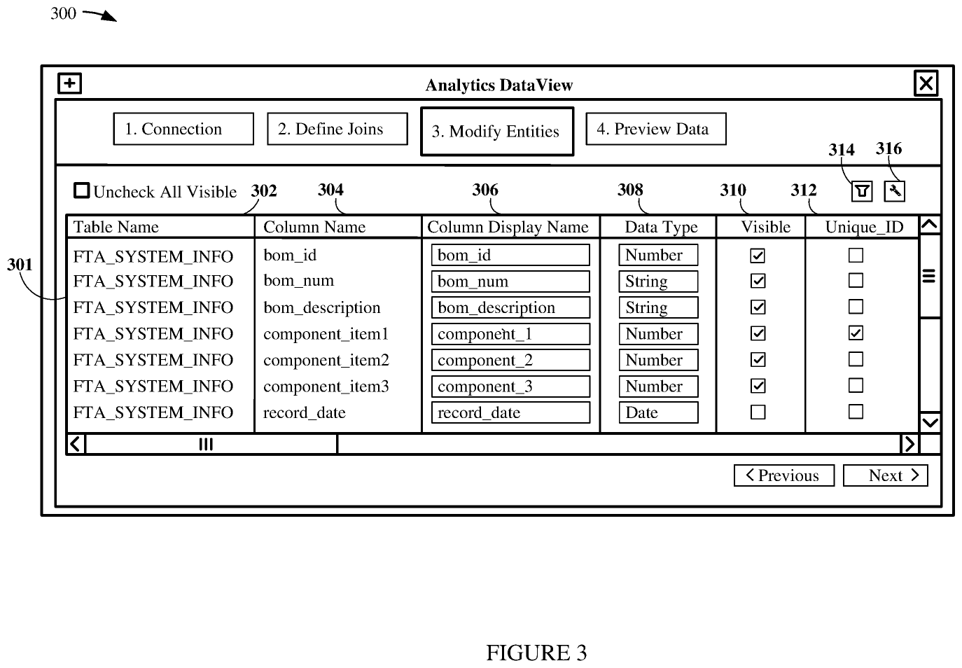

Turning to FIG. 3, a user interface 300 is illustrated in an exemplary implementation in which a data analytics service employs process 200B. In this embodiment, the data analytics service displays in table 301 an inventory of categories. In this embodiment, the inventory of categories comprises table names, column names, column display names, and data types, which are rendered in table 301 under table name 302, column name 304, column display name 306, and data type 308, respectively. Table 301 also comprises visible rule 310 and unique_id rule 312. Table 301 displays the above referenced categories and their corresponding data as columns in a table; however, other arrangements are also contemplated herein.

In this embodiment, table name 302 comprises the name of the data source from which the operational data or other information is obtained (e.g., FTA_SYSTEM_INFO). Column name 304 comprises the name of the column in the data source from which the data was retrieved (e.g., bom_id). Column display name 306 comprises the label that may be applied to a column of data when the data is presented in a preview or an axis label when the data is presented in a report (e.g., bom_id), and data type 308 indicates the data type for the displayed information (e.g., string).

User interface 300 may provide options to edit labels for some or all of the information presented in table 301. In this embodiment, the labels presented under table name 302 and column name 304 are not editable via user interface 300. A user may, however, employ user interface 300 to edit the labels and/or information displayed in column display name 306 and data type 308. For example, in the present embodiment, each label under column display name 306 initially matched the labels for their respective column names. It can be inferred that subsequent to initiating display of table 301, a user engaged user interface 300 to edit the column display name labels that correspond to column names “component_item1,” “component_item2,” and “component_item3.” As a result, when the user previews the available data, the column display name for the edited labels recites “component_1,” “component_2,” and “component_3,” respectively. A user may similarly edit the data type labels listed under data type 308 to reflect a different type of data.

A user may also engage with user interface 300 to add rules to a data set. For example, a user may apply a visibility rule to indicate which data should be visible in a report or preview. In this exemplary implementation, the user engages with one or more radial options available under visible rule 310 to indicate which data to display in a preview or report. Specifically, the user may indicate, by selecting a radial option or leaving the radial option selected, that all or portions of the available data pertaining to a specific column name should be made visible. In the present embodiment, all of the data available for every column name should be made visible (i.e., the radial buttons corresponding to the column names have been selected) except for the data that corresponds to column name “record_date.” The data corresponding to column name “record_date” should not be displayed in a preview or a report because its corresponding radial button is not selected. Visibility rules may be changed by selecting and deselecting the radial options presented under visible rule 310.

A user may also set a rule to indicate which portion of the data set should be set as a default. For example, a user may engage with one or more radial options available under unique_id rule 312 to select which data to appoint as a default. In this exemplary implementation, only data corresponding to column name “component_item1” should be set as the default because it is the only portion of the data set that has a selected radial option under unique_id rule 312. Default appointments may be changed by selecting and deselecting the radial options available under unique_id rule 312.

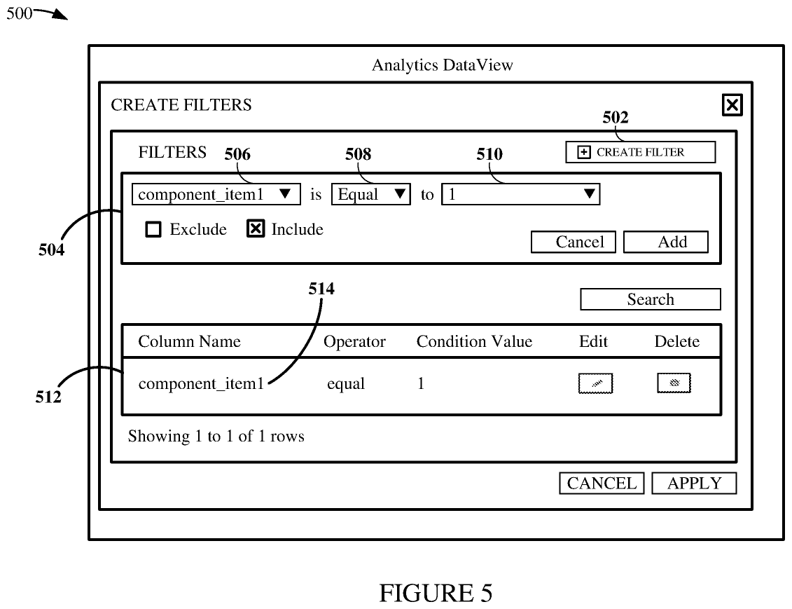

User interface 300 also comprises filter option 314. When a user selects filter option 314, the data analytics service may present a dialogue box, or other user interface object, in which to receive an indication that the data set should be filtered and how the data set is to be filtered. In the present embodiment, when a user selects filter option 314, the user interface may present “component_item1” as the default category to which to apply the generated filter because component_item1 has its corresponding radial option selected under unique_id rule 312. Filter option 314 is discussed in more detail with regard to FIG. 5.

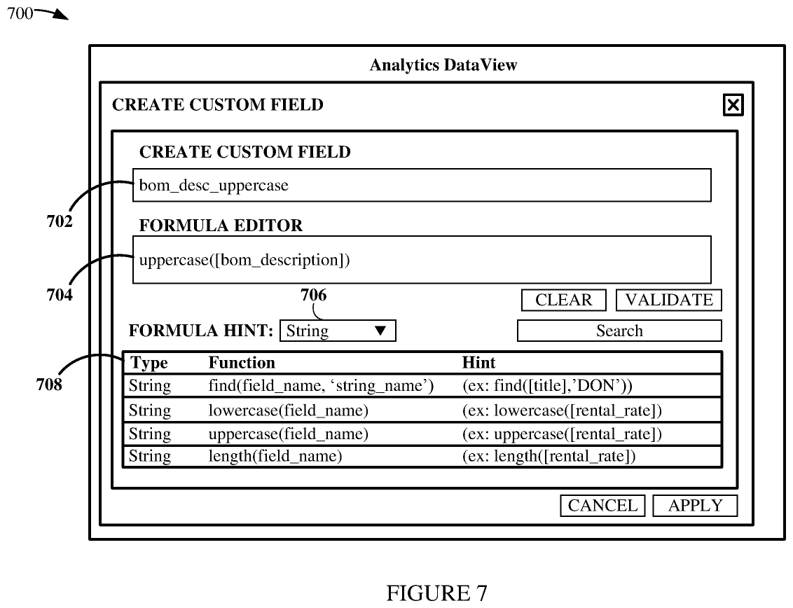

User interface 300 also comprises annotation option 316. When a user selects annotation option 316, the data analytics service may present a dialogue box, or other user interface object, in which to receive an indication that the data set should be annotated and how the data set is to be annotated. Annotation option 316 is discussed in more detail with regard to FIG. 7.

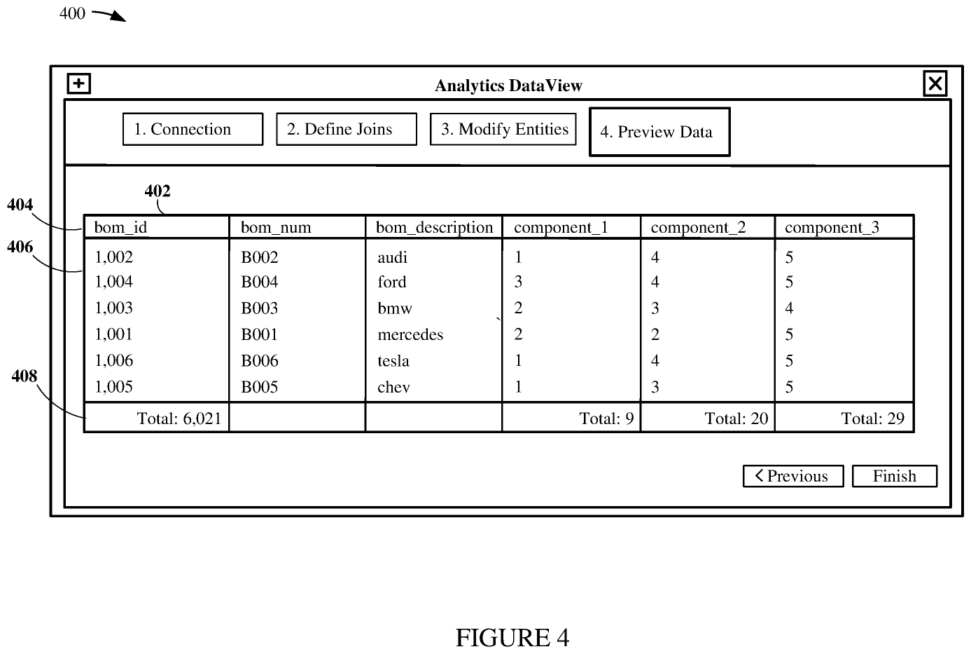

FIG. 4 illustrates a user interface 400 for previewing gathered data in an exemplary implementation. User interface 400 comprises table 402 which includes column display name row 404, data row 406, and data totals row 408. The labels presented for the categories listed in column display name row 404 correlate with the labels presented under column display name 306 of FIG. 3. As discussed with regards to FIG. 3, edits made to column display name labels via user interface 300 are reflected in previewed data and in reports. As such, the labels presented for the categories in column display name row 404 reflect the edited and unedited labels found under column display name 306.

In table 402, labels for column display name 306 that have a corresponding radial option selected under visible rule 310 are displayed. For example, in FIG. 3, column display name “record_date” does not have a corresponding radial option selected under visible rule 310. As a result, column display name “record_date” is not displayed in table 402.

Data row 406 comprises data points that correlate with the data points available for each of the respective categories listed in column display name row 404. In the present embodiment, there are six data points presented under each category listed in column display name row 404. The data points may be unique to every other data point in a respective category (e.g., the data presented for bom_id is unique to each data point in bom_id), or the data points may contain the same value as one or more other data points in the category (e.g., “component_item1” comprises three data points with a value of “1,” two data points with a value of “2,” and one data point with a value of “3”).

The information presented in data row 406 has a specific data type that correlates to the data type label presented under data type 308 of FIG. 3. For example, the data presented in table 402 under each of categories “bom_id,” “component_1,” “component_2,” and “component_3” is displayed as a number, which correlates to the “number” label presented under data type 308 for these categories. Data row 406 may also comprise string, date, and any other data types. Data totals row 408 provides total numeric values for data with a number data type. For example, the data total for the bom_id category, which has a number data type, is 6,021.

Table 402 is illustrative of a data analytics service applying only rules to an obtained data set (e.g., visibility rule 310). No filters or annotations are applied to the data presented in table 402. Therefore, in the present embodiment, all of the data points retrieved for the categories of user interface 300 having a corresponding radial option selected under visible rule 310 are displayed in table 402.

FIG. 5 illustrates a dialogue box 500 for applying one or more filters to a gathered data set in an exemplary implementation. Dialogue box 500 may be presented in a user interface to a data analytics service in response to a user indicating a desire to set a filter. For example, referencing FIG. 3, a user may select filter option 314 to indicate a desire to apply one or more filters to a data set. In the present embodiment, dialogue box 500 is presented in a user interface to computing system 114 in response to a user selecting filter option 314.

Dialogue box 500 comprises option 502, filter generator 504, and filter list 512. Option 502 may be selected to create a new filter. Filters may be applied to a data set to include or exclude information in accordance with the respective filter. Filters may limit what data is stored by a data analytics service, which may further limit the data that is ultimately loaded into a storyboard. The filter may stipulate that selected data categories should be included or excluded from a filter inventory.

Filter generator 504 comprises field values 506, 508, and 510. Field value 506 comprises at least one category derived from the data set, field value 508 comprises at least one equation operator, and field value 510 comprises at least one available data value for the gathered data that correlates to field value 506. Field values 506, 508, and 510 may comprise a dropdown menu, or any other graphical control element, that presents available input values for the respective field. For example, field value 506 may comprise a dropdown menu (or other graphical control element) with all or some of the available column names, field value 508 may comprise a dropdown menu (or other graphical control element) with all or some of the available operators, and field value 510 may comprise a dropdown menu (or other graphical control element) with all or some of the data values existing for a particular column name. Example operators include, but are not limited to, an “equal” to operator, a “greater than” operator, a “less than” operator, or any combination thereof. In the present embodiment, a user has entered into field value 506 the column name “component_item1,” into field value 508 the operator “Equal” to, and into field value 510 the data point having a value of “1.”

Filter list 512 comprises a list of all filters currently applied to the obtained data set. It can be inferred that upon presenting dialogue box 500 in the user interface, filter list 512 was empty because no filters had yet been added to the data set. Subsequent to adding the filter generated in filter generator 504, the data analytics service updates filter list 512 to include filter 514. Dialogue box 500 may comprise options to edit and/or delete the filters that are listed in filter list 512.

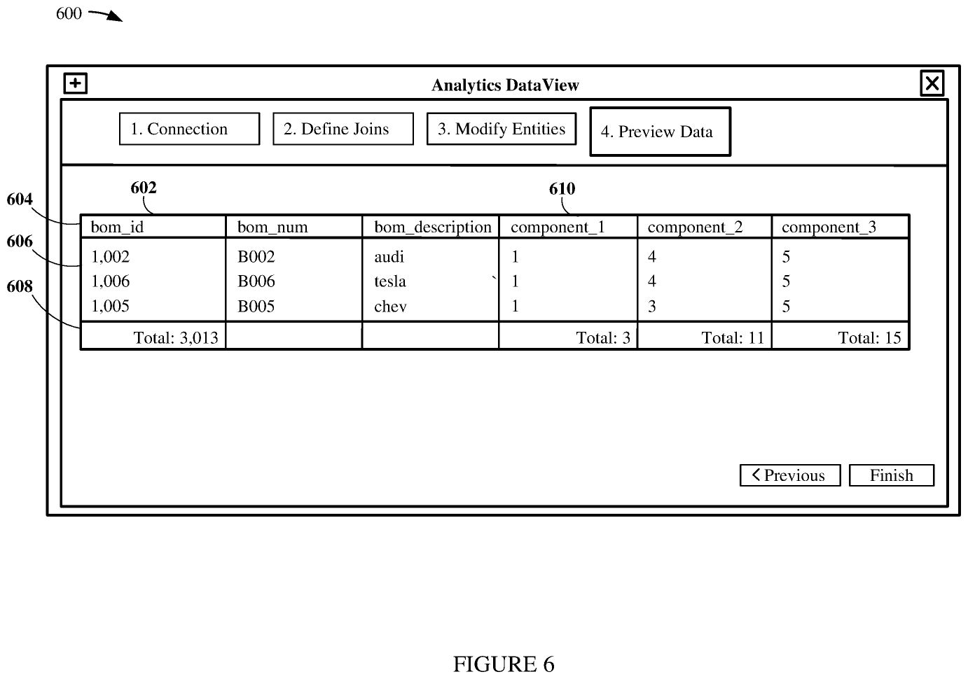

FIG. 6 illustrates a user interface 600 for previewing filtered operational data in an exemplary implementation. User interface 600 comprises table 602 which includes column display names 604, data 606, and data totals 608. The labels presented for the categories listed in column display names 604 correlate with the labels presented under column display name 306 of FIG. 3. Data 606 correlates to the information available for each of the respective categories listed in column display names 604.

In the present embodiment, table 602 illustrates the application of rules and filters to a previewed data set. Specifically, in addition to visible rule 310 of FIG. 3, the data analytics service has applied filter 514 of FIG. 5 to the gathered data set. As a result, only three data points are presented under each category listed in column display names 604. Specifically, the data analytics service has applied filter 514 to include in a preview or report only information in the data set that corresponds to when component_item1 has a value equal to one. Therefore, only three data points are presented under each category listed in column display names 604 because, as discussed with regard to FIG. 4, component_item1 comprises three data points with a value of “1.”

The information presented in data 606 has a specific data type that correlates to data type 308 of FIG. 3. For example, the data presented in table 602 under category headings “bom_id,” “component_1,” “component_2,” and “component_3” is displayed as a number, which correlates to the “number” label presented under data type 308 for these categories. Data 606 may also comprise string, date, and any other data types. Data totals 608 provide total numeric values for data with a number data type. Subsequent to the application of filter 514, the data total for the bom_id category, which has a number data type, is updated to reflect a filtered total of 3,013.

FIG. 7 illustrates a dialogue box 700 for annotating data in an exemplary implementation. The annotation function allows users to create user specific fields that may be created and customized according to business requirements. This new custom field can be added to a preview or storyboard to provide more information for analysis and assist with data validation.

Referring back to FIG. 3, a user may select annotation option 316 to indicate a desire to incorporate one or more annotations to a gathered data set. In response to selecting annotation option 316, dialogue box 700 may be presented in a user interface to the data analytics service.

Referring to FIG. 7, dialogue box 700 comprises custom field 702, formula editor 704, formula hint 706, and display table 708. A user may be prompted to supply a name value in custom field 702. The supplied name value may be used by the service to label a corresponding column name and a corresponding column display name.

A user may also be prompted to supply a formula describing how the data should be annotated for the custom field. The data analysis service may provide display table 708 to offer suggested formulas to input into formula editor 704. For example, in the present embodiment, the user indicated that the custom field will have a string data type by entering “string” into formula hint 706. In response, display table 708 provides a list of suggested formulas for fields having a “string” data type. Though a string data type is used in the present example, any data type may be entered into formula hint 706.

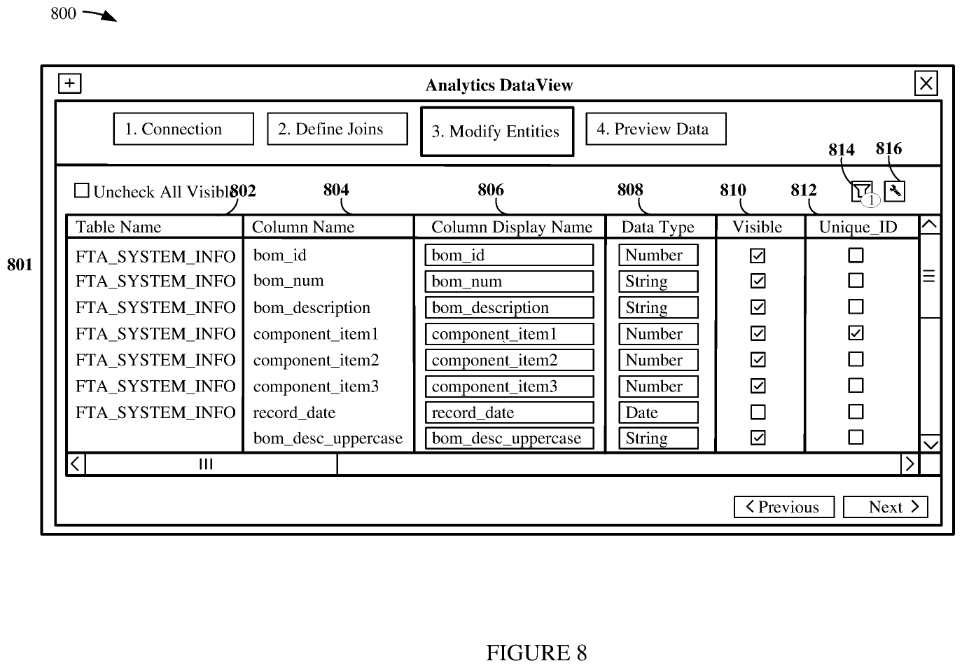

FIG. 8 illustrates a user interface 800 in an exemplary implementation in which a custom field is incorporated with a gathered data set. In this embodiment, a tailored inventory of categories is displayed and comprises table names, column names, column display names, and data types, which are rendered in table 801 under table name 802, column name 804, column display name 806, and data type 808, respectively. Table 801 also comprises visible rule 810, unique_id rule 812, filter option 814, and annotation option 816.

In this embodiment, one filter and one annotation have been applied to the gathered data set. Filter option 814 may indicate the number of filters currently applied to the data set. In the present example, filter option 814 displays a “1” to indicate that one filter is applied to the data set.

The one annotation added to table 801 was generated using dialogue box 700 of FIG. 7. The applied annotation resulted in the creation of field “bom_desc_uppercase.” As such, the label “bom_desc_uppercase” is added as a column name under column name 804 and as a column display name under column display name 806. The data type is defined automatically as a string under data type 808. Data analytics service may determine the data type from the formula entered into formula editor 704 of FIG. 7. A user may change the column display name and the default data type via user interface 800. Data analytics service may also have a default setting to make all new custom fields visible until instructed otherwise through user interface 800.

No table name is provided for the custom field “bom_desc_uppercase” under table name 802 in part because the custom field was not retrieved from a gathered data set.

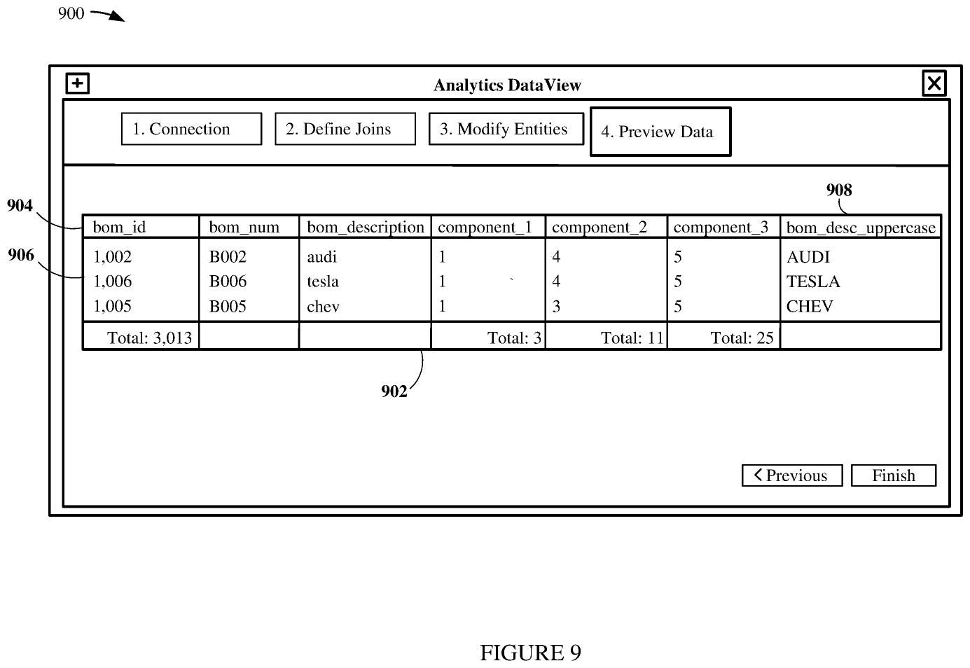

FIG. 9 illustrates a user interface 900 for previewing filtered and/or annotated data in an exemplary implementation. User interface 900 comprises table 902 which includes column display name row 904, data row 906, and custom field 908. The labels presented for the categories listed in column display name row 904 correlate with the labels presented under column display name 806 of FIG. 8. The data points presented in data row 906 correlate to the data points available for each of the respective categories listed in column display name row 904 after the data analytics service applies all existing rules and filters.

In the present embodiment, table 902 illustrates the application of rules, filters, and data annotation to a previewed data set. Specifically, in addition to visible rule 310 of FIG. 3 and filter 514 of FIG. 5, the data analytics service has applied the data annotation of FIG. 7 to generate and display custom field 908. In the custom field 908 column, data from the “bom_description” category is presented in an uppercase format. The formatting is in accordance with the formula presented in formula editor 704 of FIG. 7.

FIG. 10 illustrates computing system 1002 that is representative of any system or collection of systems in which the various processes, programs, services, and scenarios disclosed herein may be implemented. Examples of computing system 1002 include, but are not limited to, server computers, cloud computing platforms, and data center equipment, as well as any other type of physical or virtual server machine, container, and any variation or combination thereof. Other examples include desktop computers, laptop computers, table computers, Internet of Things (IoT) devices, wearable devices, and any other physical or virtual combination or variation thereof.

Computing system 1002 may be implemented as a single apparatus, system, or device or may be implemented in a distributed manner as multiple apparatuses, systems, or devices. Computing system 1002 includes, but is not limited to, processing system 1012, storage system 1004, software 1006, communication interface system 1010, and user interface system 1014. User interface system 1014 is optional in some implementations. Processing system 1012 is operatively coupled with storage system 1004, communication interface system 1010, and user interface system 1014.

Processing system 1012 loads and executes software 1006 from storage system 1004. Software 1006 includes and implements storyboard process 1008, which is representative of the storyboard processes discussed with respect to the preceding Figures. Software 1006 directs processing system 1012 to operate as described herein for at least the various processes, operational scenarios, and sequences discussed in the foregoing implementations. Computing system 1002 may optionally include additional devices, features, or functionality not discussed for purposes of brevity.

Referring still to FIG. 10, processing system 1012 may comprise a micro-processor and other circuitry that retrieves and executes software 1006 from storage system 1004. Processing system 1012 may be implemented within a single processing device but may also be distributed across multiple processing devices or sub-systems that cooperate in executing program instructions. Examples of processing system 1012 include general purpose central processing units, graphical processing units, application specific processors, and logic devices, as well as any other type of processing device, combinations, or variations thereof.

Storage system 1004 may comprise any computer readable storage media readable by processing system 1012 and capable of storing software 1006. Storage system 1004 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1004 may also include computer readable communication media over which at least some of software 1006 may be communicated internally or externally. Storage system 1004 may be implemented as a single storage device but may also be implemented across multiple storage devices or sub-systems co-located or distributed relative to each other. Storage system 1004 may comprise additional elements, such as a controller, capable of communicating with Processing system 1012 or possibly other systems.

Software 1006 (including storyboard process 1008) may be implemented in program instructions and among other functions may, when executed by processing system 1012, direct processing system 1012 to operate as described with respect to the various operational scenarios, sequences, and processes illustrated herein. For example, software 1006 may include program instructions for implementing a formula process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1006 may include additional processes, programs, or components, such as operating system software, virtualization software, or other application software. Software 1006 may also comprise firmware or some other form of machine-readable processing instructions executable by processing system 1012.

In general, software 1006 may, when loaded into processing system 1012 and executed, transform a suitable apparatus, system, or device (of which computing system 1002 is representative) overall from a general-purpose computing system into a special-purpose computing system customized to provide enhanced formula interactions. Indeed, encoding software 1006 on storage system 1004 may transform the physical structure of storage system 1004. The specific transformation of the physical structure may depend on various factors in different implementations of this description. Examples of such factors may include, but are not limited to, the technology used to implement the storage media of storage system 1004 and whether the computer-storage media are characterized as primary or secondary storage, as well as other factors.

For example, if the computer readable storage media are implemented as semiconductor-based memory, software 1006 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1010 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 1002 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

The functional block diagrams, operational sequences, and flow diagrams provided in the figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “connected” and “coupled” are used broadly and encompass both direct and indirect mounting, connecting, and coupling. Further, “connected” and “coupled” are not restricted to physical or mechanical connections or couplings, and may include electrical connections or couplings, whether direct or indirect. Also, electronic communications and notifications may be performed using any known means including direct or indirect wired connections, wireless connections, and combinations thereof. Also, functionality described as being performed by one device may be distributed among a plurality of devices.

It should also be noted that a plurality of hardware and software based devices, as well as a plurality of different structural components may be used to implement the embodiments set forth herein. In addition, it should be understood that embodiments may include hardware, software, and electronic components that, for purposes of discussion, may be illustrated and described as if the majority of the components were implemented solely in hardware. However, one of ordinary skill in the art, and based on a reading of this detailed description, would recognize that, in at least one embodiment, the electronic-based aspects of the embodiments may be implemented in software (e.g., stored on non-transitory computer-readable medium) executable by one or more electronic processors.

The included description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

What is claimed is:

1. A computer system comprising:
one or more computer readable storage media; and
program instructions stored on the one or more computer readable storage media for facilitating industrial analytics for an industrial automation operation that, when executed by one or more processors, direct the one or more processors to at least:
connect to a source of data for the industrial automation operation;
prior to saving, from the source of data, gathered data for the industrial automation operation, analyze a sample data set of the gathered data for one or more categories;
initiate, in a user interface, presentation of at least an inventory of the one or more categories;
receive a request to tailor the inventory of the one or more categories; and
tailor the inventory of the one or more categories in accordance with the request.

2. The computer system of claim 1 wherein the program instructions further direct the one or more processors to load in a search index data points that correspond to the tailored inventory of the one or more categories.

3. The computer system of claim 2 wherein the program instructions further direct the one or more processors to identify, via the search index, a context for the data points.

4. The computer system of claim 3 wherein the program instructions further direct the one or more processors to initiate in the user interface presentation of the context for the data points.

5. The computer system of claim 1 wherein to analyze the sample data set of the gathered data the program instructions further direct the one or more processors to determine a data structure for the gathered data.

6. The computer system of claim 1 wherein the request to tailor the inventory of the one or more categories comprises a filter request.

7. The computer system of claim 1 wherein the request to tailor the inventory of the one or more categories comprises an annotation request.

8. A computer-implemented method for facilitating data analytics, the method comprising:
connecting to a source of data for an industrial automation operation;
prior to saving, from the source of data, gathered data for the industrial automation operation, analyzing a sample data set of the gathered data for one or more categories;
initiating, in a user interface, presentation of at least an inventory of the one or more categories;
receiving a request to tailor the inventory of the one or more categories; and
tailoring the inventory of the one or more categories in accordance with the request.

9. The method of claim 8 further comprising loading into a search index data points that correspond to the tailored inventory of the one or more categories.

10. The method of claim 9 further comprising identifying, via the search index, a context for the data points.

11. The method of claim 10 further comprising initiating in the user interface presentation of the context for the data points.

12. The method of claim 8 wherein analyzing the sample data set of the gathered data comprises determining a data structure for the gathered data.

13. The method of claim 8 wherein the request to tailor the inventory of the one or more categories comprises a filter request.

14. The method of claim 8 wherein the request to tailor the inventory of the one or more categories comprises an annotation request.

15. One or more computer readable storage media having an application stored thereon for facilitating data analytics that, when executed by one or more processors, directs the one or more processors to at least:
connect to a source of data for an industrial automation operation;
prior to saving, from the source of data, gathered data for the industrial automation operation, analyze a sample data set of the gathered data for one or more categories;
initiate, in a user interface, presentation of at least an inventory of the one or more categories;
receive a request to tailor the inventory of the one or more categories; and
tailor the inventory of the one or more categories in accordance with the request.

16. The one or more computer readable storage media of claim 15 wherein the application further directs the one or more processors to load in a search index data points that correspond to the tailored inventory of the one or more categories.

17. The one or more computer readable storage media of claim 16 wherein the application further directs the one or more processors to identify, via the search index, a context for the data points.

18. The one or more computer readable storage media of claim 17 wherein the application further directs the one or more processors to initiate in the user interface presentation of the context for the data points.

19. The one or more computer readable storage media of claim 15 wherein the request to tailor the inventory of the one or more categories comprises a filter request.

20. The one or more computer readable storage media of claim 15 wherein the request to tailor the inventory of the one or more categories comprises an annotation request.
